(19) United States
(12) Patent Application Publication
(10) Pub. No.: US 2009/0313093 A1
(43) Pub. Date: Dec. 17, 2009

(54) OPTIMIZING GREENNESS

(76) Inventors: Ronald Patrick Doyle, Raleigh, NC (US); David Louis Kaminsky, Chapel Hill, NC (US); Edith Helen Stern, Yorktown Heights, NY (US); Barry E. Willner, Briarcliff Manor, NY (US)

Correspondence Address: HOLLAND & KNIGHT LLP, 10 ST. JAMES AVENUE, BOSTON, MA, 02116, US

(21) Appl. No.: 12/140,649

(22) Filed: Jun. 17, 2008

(51) Int. Cl. G06Q 10/00

(52) U.S. Cl. 705/11; 705/7

(57) ABSTRACT

A greenness metric is obtained for a plurality of services. The greenness metric of each of the plurality of services are compared. One or more services are determined from the plurality of services based at least in part upon the greenness metric for each of the plurality of services.

### BACKGROUND OF THE INVENTION

This disclosure relates to optimizing business factors, and more particularly to optimizing greenness.

Over the past few decades, concerns over protecting the environment have prompted many businesses to start evaluating “greener” ways to do business. Some cut down on paper consumption or power consumption, some have made efforts to reduce emissions of greenhouse gases. Many businesses rely on the services provided by other businesses and, thus, their efforts at improving greenness may be directly tied to the efforts of their business partners, suppliers, service providers, and the like.

### BRIEF SUMMARY OF THE INVENTION

In a first implementation, a method includes obtaining a greenness metric for a plurality of services. The greenness metric of each of the plurality of services may be compared. One or more services may be determined from the plurality of services based at least in part upon the greenness metric for each of the plurality of services.

According to another implementation, a computer program product resides on a computer readable medium, having a plurality of instructions stored on it. When executed by a processor, the instructions cause the processor to perform operations including obtaining a greenness metric for a plurality of services. The instructions may further cause the processor to compare greenness metric of each of the plurality of services. One or more services may be determined from the plurality of services based at least in part upon the greenness metric for each of the plurality of services.

According to yet another implementation, a computing system includes at least one processor, and at least one memory architecture coupled with the at least one processor. A first software module, which is executed on the at least one processor and the at least one memory architecture, is configured to obtain a greenness metric for a plurality of services. A second software module, which is executed on the at least one processor and the at least one memory architecture, is configured to compare the greenness metric of each of the plurality of services. A third software module, which is executed on the at least one processor and the at least one memory architecture, is configured to determine a service from the plurality of services based at least in part upon the greenness metric for each of the plurality of services.

The details of one or more implementations are set forth in the accompanying drawings and the description below. Other features will become apparent from the description, the drawings, and the claims.

### BRIEF DESCRIPTION OF THE SEVERAL VIEWS OF THE DRAWINGS

FIG. 1 diagrammatically depicts a greenness optimization process coupled to a distributed computing network.

FIG. 2 is a flowchart of a process executed by the greenness optimization process of FIG. 1.

FIG. 3 diagrammatically depicts a display screen rendered, at least in part, by the greenness optimization process of FIG. 1.

FIG. 4 diagrammatically depicts a display screen rendered, at least in part, by the greenness optimization process of FIG. 1.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

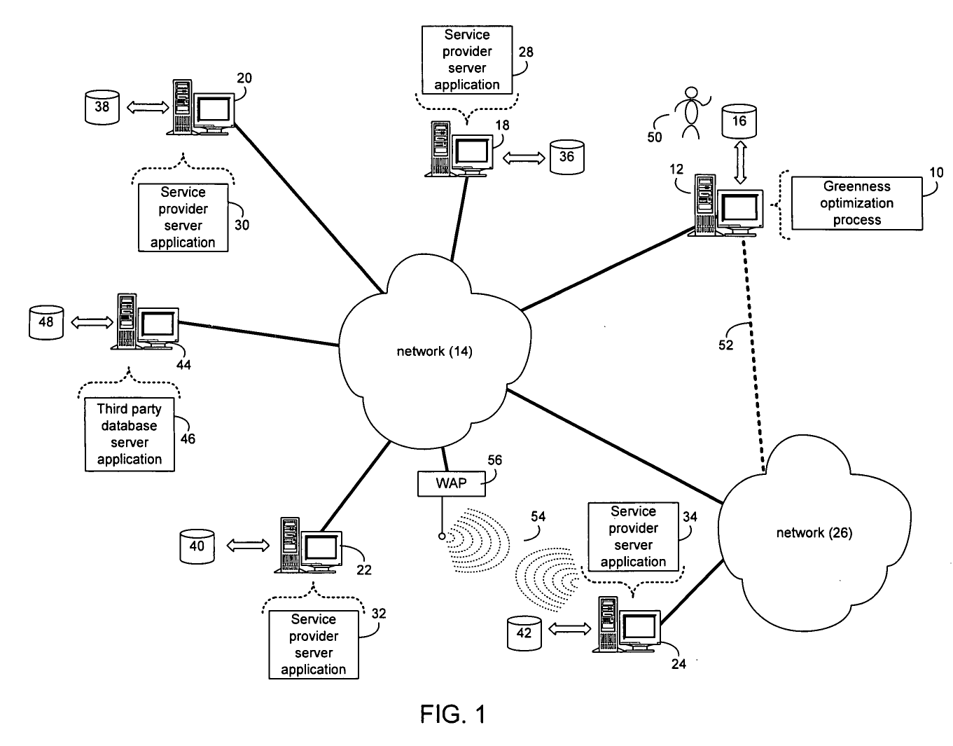

Referring to FIG. 1, there is shown greenness optimization process 10 that may reside on and may be executed by client computer 12, which may be connected to network 14 (e.g., the Internet or a local area network). Examples of client computer 12 may include, but are not limited to: a personal computer, a server computer, a series of server computers, a mini computer, and a mainframe computer. Client computer 12 may be a web server (or a series of servers) running a network operating system, examples of which may include but are not limited to: Microsoft® Windows® XP Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvales in the United States, other countries, or both). In addition, as an alternative, greenness optimization process 10 may reside on and may be executed by one or more client electronic devices, such as a personal computer, notebook computer, personal digital assistant, and data enabled cellular phone, for example.

As will be discussed below in greater detail, greenness optimization process 10 may obtain and compare greenness metrics for a plurality of services. One or more services may be determined from the plurality of services based at least in part upon the greenness metric for each of the plurality of services.

The instruction sets and subroutines of greenness optimization process 10, which may include one or more software modules and which may be stored on storage device 16 coupled to client computer 12, may be executed by one or more processors (not shown) and one or more memory architectures (not shown) incorporated into client computer 12. Storage device 16 may include but is not limited to: a hard disk drive; a solid state drive; a tape drive; an optical drive; a RAID array; a random access memory (RAM); and a read-only memory (ROM).

Client computer 12 may interact with one or more service provider servers (e.g., service provider servers 18, 20, 22, and 24), e.g., via network 14. Service provider server computers 18, 20, 22 and 24 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other Countries, or both). Network 14 may be connected to one or more secondary networks (e.g., network 26), examples of which may include but are not limited to: a local area network; a wide area network; or an intranet, for example.

Each service provider server (e.g., service provider servers 18, 20, 22, 24) may each execute one or more service provider server applications (e.g., service provider server applications 28, 30, 32, 34). Service provider server applications 28, 30, 32, 34 may include software applications which are provided as a service, e.g., which may be accessed by client computer 12 via one or more of networks 14, 26. Service provider server applications 28, 30, 32, 34 may provide, e.g., outsourced data storage, outsourced computing, information services (e.g., stock quotes, weather information), third party hosted and operated software (e.g., financial software, email software, information management software, etc.). Service provider server applications 28, 30, 32, 34 may be accessed by client computer 12 via a web browser (not shown), application specific application programming interface (not shown) or the like. Additionally, service provider server applications 28, 30, 32, 34 may be queried by greenness optimization process 10 to provide a greenness metric associated with respective service provider server applications 28, 30, 32, 34.

The instruction sets and subroutines of service provider server applications (e.g., service provider server applications 28, 30, 32, and 34) which may be stored on storage devices 36, 38, 40 and 42 (respectively) coupled to service provider server computers 18, 20, 22, 24 (respectively), may be executed by one or more processors (not shown) and one or more memory architectures (not shown) incorporated into service provider server computers 18, 20, 22, 24 (respectively). Storage devices 36, 38, 40 and 42 may include but are not limited to: hard disk drives; solid state drives; tape drives; optical drives; RAID arrays; random access memories (RAM); read-only memories (ROM), compact flash (CF) storage devices, secure digital (SD) storage devices, and memory stick storage devices.

Additionally/alternatively, greenness optimization process 10 may query a third party server computer, e.g., third party server computer 44, via network 14 for greenness metrics for a plurality of services provided by one or more service providers (e.g., service provider server applications 28, 30, 32, 34 executed by service provider servers 18, 20, 22, 24). For example, third party server computer 44 may execute third party database server application 46, e.g., which may include greenness metric data associated with service provider server applications 28, 30, 32, 34 and may be queried by greenness optimization process 10.

Third party server computer 44 may execute a web server application, examples of which may include but are not limited to: Microsoft IIS, Novell Webserver, or Apache Webserver, that allows for HTTP (i.e., HyperText Transfer Protocol) access to server computer 12 via network 14. Third party database server application 46 may reside on third party server computer 44. The instruction sets and subroutines of third party database server application 46, which may be stored on storage device 48 coupled to third party server computer 44, may be executed by one or more processors (not shown) and one or more memory architectures (not shown) incorporated into third party server computer 44. Storage device 48 may include but is not limited to: a hard disk drive; a tape drive; an optical drive; a RAID array; a random access memory (RAM); and a read-only memory (ROM). Third party database server application 46 may be configured to manage greenness metrics and other related information for a plurality of services provided by one or more service providers.

A user, e.g., user 50, may utilize greenness optimization process 10 to obtain greenness metrics (e.g., from one or more of service provider server computers 18, 20, 22, 24, and/or from third party server computer 44) directly through network 14 or through secondary network 26. Further, client computer 12 (i.e., the computer that executes greenness optimization process 10) may be connected to network 14 through secondary network 26, as illustrated with phantom link line 52.

The client computer 12 and the various service provider server computers (e.g., service provider server computers 18, 20, 22, 24) may be directly or indirectly coupled to network 14 (or network 26). For example, notebook computer 24 is shown wirelessly coupled to network 14 via wireless communication channel 54 established between laptop computer 24 and a wireless access point (i.e., WAP) 56, directly coupled to network 14. WAP 56 may be, for example, an IEEE 802.11a, 802.11b, 802.11g, Wi-Fi, and/or Bluetooth device that is capable of establishing wireless communication channel 54 between laptop computer 24 and WAP 56. Further, third party server computer 44 is shown directly coupled to network 14 via a hardwired network connection.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client computer 12 may each execute an operating system, examples of which may include but are not limited to Microsoft Windows, Microsoft Windows CE, Redhat Linux, or a custom operating system.

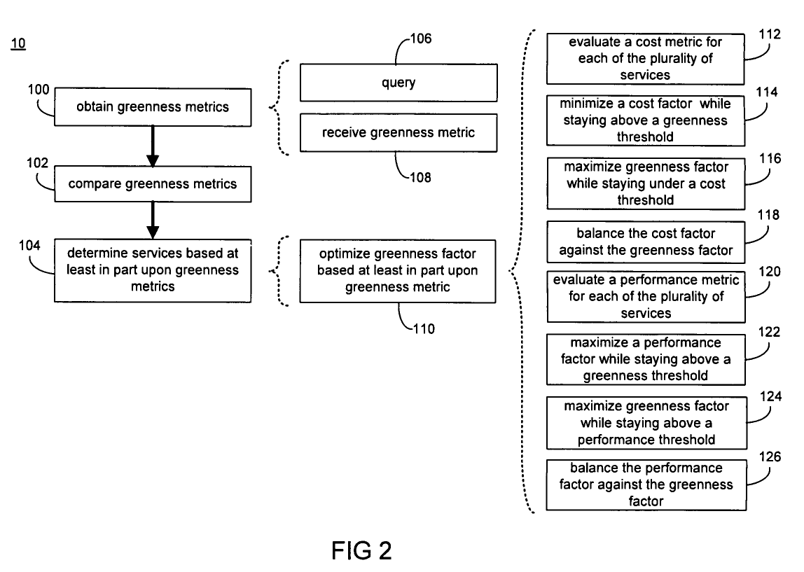

Referring also to FIG. 2, greenness optimization process 10 may obtain 100 a greenness metric for a plurality of services. Greenness optimization process 10 may compare 102 the greenness metric of each of the plurality of services. Greenness optimization process 10 may further determine 104 one or more services from the plurality of services based at least in part upon the greenness metric for each of the plurality of services.

For example, a business may outsource particular aspects of their operations and rely on one or more external service providers for those services. Examples of services which may be outsourced may include, but are not limited to, data storage, computing resources, software (e.g., by utilizing software as a service paradigm), etc., as well as services that provide maps, directions, stock quotes, weather information, etc. A greenness metric may be associated with one or more services offered by one or more service providers, and/or with each of one or more service providers. For example, each of the one or more service providers may have a variety of greenness metrics to the extent that a given service provider offers more than one service and/or provides one or more services from and/or in more than one location.

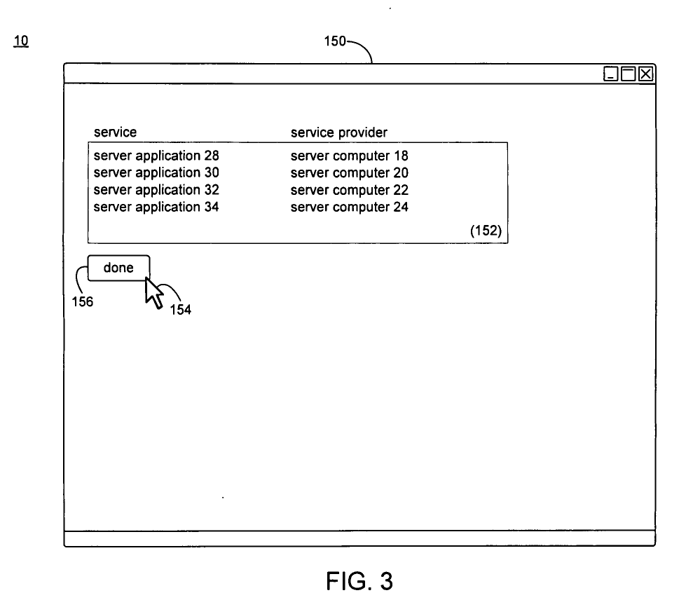

For example, and referring also to FIG. 3, greenness optimization process 10, alone or in conjunction with one or more other applications (e.g., a web browser, not shown) may render display screen 150. A user (e.g., user 50) may identify one or more services (e.g., which may be performed by service provider server applications 28, 30, 32, 34) by inputting (e.g., via a keyboard, not shown) one or more services (e.g. service provider server applications 28, 30, 32, 34) and/or one or more service providers (e.g., service provider server computers 18, 20, 22, 24) in input region 152 of display screen 150. Once the service and/or service providers (i.e., service provider server computers 18, 20, 22, 24) have been input, user 50 may select, via onscreen pointer 154 (which may be controlled by a pointing device, such as a mouse; not shown) done button 156. According to one embodiment, a list of services and/or service providers may be retrieved from a registry (e.g., a database) of services and/or service providers. Such a registry may be maintained locally and/or may be maintained by a third party (e.g., IBM® WebSphere® service registry and repository; IBM and WebSphere are registered trademark of International Business Machines Corporation in the United States, other countries, or both) A user (e.g., user 50) may select one or more services and/or service providers from information retrieved from the registry.

Selecting done button 156 may cause greenness optimization process 10 to obtain 100 greenness metrics of the plurality of services. To obtain 100 greenness metrics associated with the plurality of services, greenness optimization process 10 may query 106 each service provider for greenness metrics associated with one or more services offered by that service provider. For example, greenness optimization process 10 may query 106 one or more of service provider server computers 18, 20, 22, 24 to obtain 100 the greenness metrics. Additionally/alternatively, greenness optimization process 10 may obtain 100 greenness metrics by querying 106 a third party database, e.g., by querying third party server computer 44, where compiled greenness metrics and related data associated with the plurality of service providers may be stored, e.g., via third party database server application 46. In the event that a service does not have a greenness metric associated with it, and/or the greenness metric is not accessible, obtaining 100 a greenness metric for the service may include assigning a greenness metric to the service (e.g., which may indicate a neutral greenness metric, a null greenness metric, a poor greenness metric, or the like, depending upon preferences and/or design criteria). In addition/as an alternative to obtaining 100 greenness metrics in response to a user action (e.g., clicking done button 156), greenness optimization process 10 may obtain 100 greenness metrics automatically upon user identification of one or more services and/or one or more service providers.

The greenness metric for each service may be based upon a variety of factors such as a power consumption factor associated with each of the plurality of services, a location associated with each of the plurality of services, and a carbon offset utilization associated with each of the plurality of services. Continuing with the above example, a service provider may offer services out of several different facilities and/or in more than one location. Similarly, the services being compared 102 may be provided by different service providers operating in different locations. Services offered out of a relatively new facility (e.g., which may be configured to conserve energy) may have a more favorable, or more green, greenness metric than services offered out of an antiquated facility (e.g., which may be less energy efficient). Similarly, services offered out of a “clean” city, e.g., a city with strict environmental regulations, may have a more favorable greenness metric than services offered out of a city that has few environmental controls in place. Additionally, services offered by a service provider that utilizes carbon offsets may have a more favorable greenness metric than a service offered by a service provider who does not utilize carbon offsets.

The greenness metric may be based upon one or more of a greenness units per second and a greenness units per transaction. For example, for transactional services, the greenness metric may be expressed in terms of greenness units per transaction. For long-running services, the greenness metric may be expressed in terms of greenness units per second or any other appropriate increment of time such as minutes or hours. While any suitable scale or arrangement may be employed, for the purpose of the following description it will be assumed that the greenness metric may be expressed as a scale with a high greenness metric being optimal or favorable and a low greenness metric being undesirable.

In response to greenness optimization process 10, querying 106 one or more of service provider server computers 18, 20, 22, 24 and/or third party server computer 44, one or more of service provider server computers 18, 20, 22, 24 (e.g., one or more of service provider server applications 28, 30, 32, 34) and/or third party database server application 46 may transmit a greenness metric associated with one or more services. Greenness optimization process 10 may receive 108 the transmitted greenness metric associated with the one or more services.

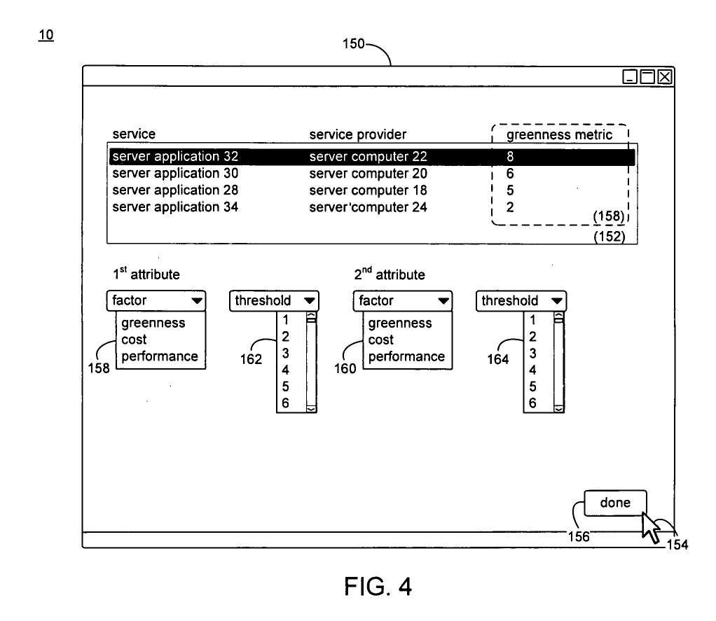

Continuing with the above-stated example, and referring also to FIG. 4, greenness optimization process 10 (alone or in conjunction with one or more other applications) may return results set 158 of greenness metrics associated with each of service provider server applications 28, 30, 32, 34 (e.g., a greenness metric of 8 associated with server application 32, a greenness metric of 6 associated with server application 30, a greenness metric of 5 associated with server application 28, and a greenness metric of 2 associated with server application 34). Greenness optimization process 10 may compare 102 the greenness metric obtained 100 for each of the plurality of services. For example, for similar (e.g., comparable) services (i.e., service provider server applications 28, 30, 32, 34) offered by one or more service providers (e.g., via server computers 18, 20, 22, 24), greenness optimization process 10 may compare 102 the greenness metric associated each of the services to determine any difference in the greenness metric for each service, e.g., based upon, at least in part, the obtained 100 greenness metrics.

Greenness optimization process 10 may determine 104 one or more services from the plurality of services based at least in part upon the greenness metric for each of the plurality of services. Greenness optimization process 10 may determine 104 (e.g., indicated by highlighting, providing a listing based upon, at least in part, greenness metric, etc.) the service or services that have the most favorable greenness metric determined by comparing 102 the obtained 100 greenness metrics of the services (e.g., service provider server applications 28, 30, 32, 34; which may represent service provided by one or more service providers and/or one or more service providers from different locations). Greenness optimization process 10 may determine 104 one or more services, e.g., which may be provided by different service providers, one or more services provided by a single service provider (e.g., based out of different facilities of the service provider), and/or various combinations thereof.

Greenness optimization process 10 may determine 104 one or more services based upon, at least in part, various factors in addition to greenness metric. For example, greenness optimization process 10 may optimize 110 a greenness factor for a specified application based at least in part upon the greenness metric. Optimizing 110 a greenness factor for a specified application may include determining 104 one or more services based upon, at least in part, greenness metric and taking into account various other factors and/or concerns. For example, greenness optimization process 10 may be configured to evaluate various factors, including greenness metric, for the purpose of optimizing 110 greenness while also optimizing the other factors, e.g., which may include a balancing of all factors. Optimizing 110 a greenness factor for a specific application may result in greenness optimization process 10 determining 104 a service that has a favorable greenness metric, though not the most favorable greenness metric, if determining the service with the most favorable greenness metric would adversely impact the other factors under consideration. Greenness optimization process 10 may be configured or preprogrammed with parameters and/or thresholds for each factor under consideration in optimizing 110 greenness for a specified application.

Greenness optimization process 10 may optimize 110 a greenness factor for a specified application, taking into account cost of the service. As such, greenness optimization process 10 may evaluate 112 a cost metric for each of the plurality of services. Similar to the associated greenness metric, a cost associated with each of the one or more services may vary from service to service (e.g., a different cost may be associated with each of server applications 28, 30, 32, 34). The cost metric associated with each of the one or more services (e.g., the cost per transaction or cost per unit time, as appropriate) may be obtained, e.g., from a respective service provider (e.g., an operator of the various services) and/or from one or more third parties (e.g., cost information by be requested and received from third party database application 46).

For example, taking cost into consideration, greenness optimization process 10 may minimize 114 a cost factor (based upon the cost metric associated with each of the plurality of services) while staying under a greenness threshold. For example, and with continued reference to FIG. 4, user 50 may select, via onscreen pointer 154, greenness from dropdown menu 158 as an attribute to maximize. Additionally, user 50 may select, via onscreen pointer 154, cost from dropdown menu 160 as an attribute to minimize. Further, user 50 may define a greenness threshold, (e.g., a lower threshold value of the greenness metric), e.g., by selecting a desired value from dropdown menu 162. Greenness optimization process 10 may evaluate 112 a cost metric associated with each of the one or more services, and may determine 104 one or more service that minimizes 114 the cost factor while staying above a minimum greenness threshold.

Additionally/alternatively, greenness optimization process 10 may maximize 116 the greenness factor while staying under a cost threshold. Continuing with the above example, user 50 may select, via onscreen pointer 154, greenness from dropdown menu 158 as an attribute to be maximized. User 50 may further select, via onscreen pointer 154, cost from dropdown menu 160 as an attribute to be minimized. Further, user 50 may select, via onscreen pointer 154, a cost threshold from dropdown menu 164. Greenness optimization process 10 may evaluate 112 a cost metric associated with each of the one or more services, and may determine 104 one or more of the one or more services that maximized greenness while staying under a defined cost threshold value.

Additionally/alternatively, greenness optimization process 10 may balance 118 the cost factor against the greenness factor. Continuing with the above example, user 50 may select, via dropdown menus 158, 160 using onscreen pointer 154, greenness as an attribute to maximize and cost as an attribute to minimize, without specifying threshold limits for either greenness or cost. Greenness optimization process 10 may evaluate 112 the cost metrics and greenness metrics associated with each of the one or more services. Greenness optimization process 10 may determine 104 one or more of the one or more services having the highest associated greenness metric and the lowest associated cost metric.

Optimizing 110 a greenness factor for a specified application, may include optimizing one or more of a greenness metric and a performance metric associated with one or more of the one or more services. The plurality of services may each have different associated performance level. Greenness optimization process 10 may evaluate 120 a performance metric associated with each of the plurality of services. For example, a performance metric for each of the one or more services may be known, e.g., based upon data from the one or more service providers (e.g., based upon a query of respective service provider server applications 28, 30, 32, 34) and/or data from one or more third parties (e.g., based upon a query of third party database server application 46). Greenness optimization process 10 may evaluate 120 a performance metric associated with each service to determine the impact of the performance metric on greenness optimization 110.

For example, and similar to the above-described optimization 110 of cost and greenness, user 50 may select, from dropdown menus 158, 160, greenness and performance as optimization attributes. User 50 may further define a threshold value to be associated with one or more of greenness and performance for the purpose of optimization. For example, user 50 may select, from dropdown menu 162, a minimum threshold greenness metric value. Greenness optimization process 10 may determine 104 one or more of the one or more services to maximize 122 performance while staying above the defined greenness threshold.

Alternatively, greenness optimization process 10 may maximize 124 a greenness factor while staying above a performance threshold. For example, in addition as an alternative to defining a greenness threshold, user 50 may define a performance threshold (e.g., via dropdown menu 164). Greenness optimization process 10 may determine 104 one or more of the one or more services that maximizes 124 greenness while staying above the defined performance threshold.

Further, optimizing 110 a greenness factor for a specific application based upon, at least in part, the greenness metric may include balancing 126 a performance factor against the greenness factor. For example, as described above, user 50 may select (from dropdown menus 158, 160) greenness and performance as attributes to be optimized, without specifying a threshold value for either performance or greenness. Greenness optimization process 10 may evaluate 120 the performance metrics associated with each of the one or more services. Greenness optimization process 10 may determine 104 one or more services having highest combined, or balanced, greenness metric and performance metric.

While the foregoing description has relied upon at least some degree of user intervention (e.g., including selecting items from dropdown menus 158, 160, and the like), it should be appreciated that greenness optimization process 10 may operate without user intervention. For example, as discussed above, greenness optimization process 10 may be configured or preprogrammed with predefined greenness thresholds, cost thresholds and performance thresholds and/or balancing requirements for a given application. Greenness optimization process 10 may evaluate the greenness metric, cost metric and/or performance metric based upon the predefined thresholds and balancing requirements. As such, greenness optimization process 10 may operate automatically based upon, at least in part, a policy including at least one predetermined threshold, balancing factor, or the like.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
obtaining a greenness metric for a plurality of services;
comparing the greenness metric of each of the plurality of services; and
determining a service from the plurality of services based at least in part upon the greenness metric for each of the plurality of services.

2. The method of claim 1, wherein the greenness metric is based upon at least one of:
a power consumption,
a location, and
a carbon offset utilization.

3. The method of claim 1, wherein the greenness metric is based upon at least one of a greenness units per second and a greenness units per transaction.

4. The method of claim 1, wherein determining a service from the plurality of services based at least in part upon the greenness metric for each of the plurality of services comprises optimizing a greenness factor for a specified application based at least in part upon the greenness metric.

5. The method of claim 4, wherein optimizing a greenness factor for a specified application comprises evaluating a cost metric for each of the plurality of services.

6. The method of claim 5, wherein optimizing a greenness factor for a specified application comprises at least one of:
minimizing a cost factor based upon the cost metric for each of the plurality of services while staying above a greenness threshold;
maximizing the greenness factor while staying under a cost threshold; and
balancing the cost factor against the greenness factor.

7. The method of claim 4, wherein optimizing a greenness factor for a specified application comprises evaluating a performance metric for each of the plurality of services.

8. The method of claim 7, wherein optimizing a greenness factor for a specified application comprises at least one of:
maximizing a performance factor based upon the performance metric for each of the plurality of services while staying above a greenness threshold;
maximizing the greenness factor while staying above a performance threshold; and
balancing the performance factor against the greenness factor.

9. The method of claim 1, wherein obtaining the greenness metric for the plurality of services comprises querying at least one of a service provider and a third party for the greenness metric for each of the plurality of services.

10. The method of claim 9, wherein obtaining the greenness metric for the plurality of services comprises receiving a greenness metric from at least one of a service provider and a third party for each of the plurality of services.

11. A computer program product residing on a computer readable medium having a plurality of instructions stored thereon which, when executed by a processor, cause the processor to perform operations comprising:
obtaining a greenness metric for a plurality of services;
comparing the greenness metric of each of the plurality of services; and
determining a service from the plurality of services based at least in part upon the greenness metric for each of the plurality of services.

12. The computer program product of claim 11, wherein the greenness metric is based upon at least one of:
a power consumption factor,
a location and
a carbon offset utilization.

13. The computer program product of claim 11, wherein the greenness metric is based upon at least one of a greenness units per second and a greenness units per transaction.

14. The computer program product of claim 11, wherein determining a service from the plurality of services based at least in part upon the greenness metric for each of the plurality of services comprises optimizing a greenness factor for a specified application based at least in part upon the greenness metric.

15. The computer program product of claim 14, wherein optimizing a greenness factor for a specified application comprises evaluating a cost metric for each of the plurality of services.

16. The computer program product of claim 15, wherein optimizing a greenness factor for a specified application comprises at least one of:
minimizing a cost factor based upon the cost metric for each of the plurality of services while staying above a greenness threshold;
maximizing the greenness factor while staying under a cost threshold; and
balancing the cost factor against the greenness factor.

17. The computer program product of claim 14, wherein optimizing a greenness factor for a specified application comprises evaluating a performance metric for each of the plurality of services.

18. The computer program product of claim 17, wherein optimizing a greenness factor for a specified application comprises at least one of:
maximizing a performance factor based upon the performance metric for each of the plurality of services while staying above a greenness threshold;
maximizing the greenness factor while staying above a performance threshold; and
balancing the performance factor against the greenness factor.

19. The computer program product of claim 11, wherein obtaining the greenness metric for the plurality of services comprises querying at least one of a service provider and a third party for the greenness metric for each of the plurality of services.

20. A computing system comprising:
at least one processor;
at least one memory architecture coupled with the at least one processor;
a first software module executed on the at least one processor and the at least one memory architecture, wherein the first software module is configured to obtain a greenness metric for a plurality of services;
a second software module executed on the at least one processor and the at least one memory architecture, wherein the second software module is configured to compare the greenness metric of each of the plurality of services; and
a third software module executed on the at least one processor and the at least one memory architecture, wherein the third software module is configured to determine a service from the plurality of services based at least in part upon the greenness metric for each of the plurality of services.
